(19) United States
(12) Patent Application Publication
(10) Pub. No.: US 2026/0127549 A1
(43) Pub. Date: May 7, 2026

(54) GENERATING AN INSTALLATION WORK PACKAGE BASED ON BLOCK BOUNDARIES ESTABLISHED BY A VIRTUAL GRID

(71) Applicant: Darrin C. Jones, Houston, TX (US)

(72) Inventor: Darrin C. Jones, Houston, TX (US)

(21) Appl. No.: 18/940,538

(22) Filed: Nov. 7, 2024

(51) Int. Cl. G06Q 10/10; G06Q 10/0631; G06Q 50/08

(52) U.S. Cl. CPC G06Q 10/103; G06Q 10/06313; G06Q 50/08

(57) ABSTRACT

A method and computer program product may include or cause the performance of various operations. The operations include accessing a construction work package that identifies a plurality of construction drawings that are collectively necessary for physical execution of a construction project covering a construction work area (CWA), wherein each construction drawing includes the design of one or more components and a location within the CWA for each of the components. The operations further include generating a virtual grid overlaying the CWA, wherein the virtual grid divides the CWA into a plurality of blocks having defined boundaries. Still further, the operations include generating, for one or more blocks, an installation work package that includes the construction drawings from the construction work package that are necessary for physical execution of that portion of the construction project within the construction work area that is within the defined boundaries of the block.

### BACKGROUND

The present disclosure relates to construction management, including the use of advanced work packaging software applications to manage and schedule construction work.

### BACKGROUND OF THE RELATED ART

Construction project management is a professional service that includes effective management of a project's schedule, cost, quality, safety, scope and/or function. Essentially, construction project management may include any aspect of oversight over a construction project.

A set of best practices for construction project management is known as “Advanced Work Packaging” (AWP). Advanced Work Packaging is the systematic application of proven construction practices that enable productive activity. These practices guide the division of project scope to support the execution of workface planning across the construction work area (CWA).

Engineering work packages and procurement work packages are combined to form a construction work package (CWP) that identifies all of the drawings, equipment and materials needed for execution of the construction project. An information manager is responsible for developing procedures that will guide the generation and management of project data. A construction manager or construction team may then divide the construction work package into multiple installation work packages (IWPs). However, workface planning (WFP) is a process performed by a workface planning coordinator to identify the drawings, equipment and materials needed by a construction foreman and their trades people to perform the actual construction of some part of the construction project. Having the necessary drawings (documents/information), equipment (tools) and materials (supplies) available at the appropriate time leads to an increase in productivity and keeps the construction progress on schedule. Evidence suggests that these practices also lead to increased safety performance and higher quality construction.

### BRIEF SUMMARY

Some embodiments provide a computer program product comprising a non-transitory computer readable medium and program instructions embodied therein, where the program instructions are configured to be executable by a processor to cause the processor to perform various operations. The operations comprise accessing a construction work package that identifies a plurality of construction drawings that are collectively necessary for physical execution of a construction project covering a construction work area, wherein each construction drawing includes the design of one or more components and a location within the construction work area for each of the components. The operations further comprise generating a virtual grid overlaying the construction work area, wherein the virtual grid divides the construction work area into a plurality of blocks having defined boundaries. Still further, the operations comprise generating, for one or more blocks, an installation work package that includes the construction drawings from the construction work package that are necessary for physical execution of that portion of the construction project within the construction work area that is within the defined boundaries of the block.

### BRIEF DESCRIPTION OF THE SEVERAL VIEWS OF THE DRAWINGS

FIG. 1 is a diagram of a system in which a user computer can access and utilize an advanced work packaging (AWP) software application according to some embodiments.

FIG. 2 is a diagram of a computer or server according to some embodiments.

FIG. 3 is a diagram of a plot plan for a construction project for which a construction work package (CWP) has been prepared using the advanced work packaging software application.

FIG. 4 is a diagram of a virtual grid overlaying the plot plan of the construction project according to some embodiments.

FIG. 5A is a table representing the content of an installation work package (IWP) that portion of the construction project located with block 3C03 of the virtual grid.

FIG. 5B is a construction drawing for a first pipe located within the block 3C03.

FIG. 5C is a construction drawing for a second pipe located within the block 3C03.

FIG. 5D is a construction drawing for a third pipe located within the block 3C03.

FIG. 5E is a construction drawing for a fourth pipe located within the block 3C03.

FIG. 5F is a construction drawing for a fifth pipe located within the block 3C03.

### DETAILED DESCRIPTION

Some embodiments provide a computer program product comprising a non-transitory computer readable medium and program instructions embodied therein, where the program instructions are configured to be executable by a processor to cause the processor to perform various operations. The operations comprise accessing a construction work package that identifies a plurality of construction drawings that are collectively necessary for physical execution of a construction project covering a construction work area, wherein each construction drawing includes the design of one or more components and a location within the construction work area for each of the components. The operations further comprise generating a virtual grid overlaying the construction work area, wherein the virtual grid divides the construction work area into a plurality of blocks having defined boundaries. Still further, the operations comprise generating, for one or more blocks, an installation work package that includes the construction drawings from the construction work package that are necessary for physical execution of that portion of the construction project within the construction work area that is within the defined boundaries of the block.

The computer program product may be included in, or work in conjunction with, an advanced work packaging (AWP) software application. Advanced work packaging software is a construction planning and collaboration system that improves efficiency and reduces delays in construction projects. For example, advanced work packaging software may be used to prepare a construction work package (CWP), manage information sharing or dissemination among members of the project team, and perform workface planning. Optionally, the workface planning functionality may be performed by a separate software application that interfaces with the advanced work packaging software application.

The construction work package is a collection of digital files or data that represent the logical scope of construction project to be performed in a construction work area (CWA). The digital files or data of the construction work package may include both one or more engineering work packages (EWP) and a procurement work package (PWP). The engineering work packages contain all of the engineering data required for the construction work package, such as the scope of work, drawings, vendor data, bill of materials, and specifications. Furthermore, a plurality of engineering work packages may identify a sequence in which those engineering work packages are to be performed or constructed. Optionally, the engineering data may be in the form of documents, such as portable document format (PDF) documents, or in the form of a three-dimensional (3D) model. A procurement work package identifies all of the materials that are required to construct the construction work package. Optionally, each engineering work package and/or each procurement package may be limited to a particular trade discipline.

The plurality of construction drawings may detail the construction of one or more components or portions of the construction project. In the context of a construction project for building a chemical processing plant, the one or more components of a construction drawing may include, without limitation, a foundation, a steel support structure, a pipe, a tank or vessel, or instruments and electronics. The drawing may, without limitation, include an isometric drawing, a three-dimensional image, and/or one or more side, top, bottom and/or cross-sectional views of the one or more components. The type of drawing and number of views of a component may reflect the construction complexity of the component.

In some embodiments, the construction project may be represented by a three-dimensional model. The three-dimensional model may be generated from, or link to, the construction drawings. Alternatively, the construction drawings may be generated from the three-dimensional model. As used herein, the term “construction drawings” is intended to encompass any image of the one or more components that provides data necessary to construct the one or more components.

The construction work area may be considered to be a plan view (top or aerial view) of the construction project. Accordingly, the construction work area is treated as a two-dimensional area in which the construction project will be constructed. While the construction work area may have any shape or size, the location of components within the construction work area may be identified using a coordinate system, such as a cartesian coordinate system. Without limitation, the cartesian coordinate system may be aligned with a cardinal direction (i.e., north south, east and west, where the north and south directions are perpendicular to the east and west directions). For example, a coordinate system may identify the location of a point on a component by a distance north and a distance west from an established monument or other fixed location.

The virtual grid is used to divide the construction work area into a plurality of blocks having defined boundaries. In one option, a plan view or map of the construction work area may be displayed or output with the virtual grid illustrated overlaying the construction work area. Such a map may assist users to identify the locations of the individual blocks of the virtual grid and view the components of the construction project that are to be constructed within that portion of the construction work area. However, the virtual grid may be used to divide the construction work area into a plurality of blocks without illustrating the virtual grid overlaying the construction work area. For example, the virtual grid may establish the boundaries of each block and the boundaries of any given block may be used as a search filter to identify each of the constructions drawings for components located within the boundaries of the given block. A plan view or map of the construction work area with an overlay of the virtual grid may, however, help users to identify one or more specific blocks of the virtual grid for which they want additional information, such as the generation of an installation work package. In one example, each block of the virtual grid may be rectangular. It is a technical advantage of some embodiments that the virtual grid may be automatically generated such that the boundaries of each block are identified by the virtual grid. Accordingly, an installation work package may be generated for any selected one or more of the blocks using the automatically generated boundaries of the selected one or more of the blocks.

In some embodiments, the virtual grid may establish an x-axis and a y-axis (i.e., a cartesian coordinate system), wherein the boundaries of each block are established by a range of x-coordinates and a range of y-coordinates, and wherein the installation work package includes some or all of the construction drawings that have a location with an x-coordinate within the range of x-coordinates for the block and a y-coordinate within the range of y-coordinates for the block. Optionally, the x-axis of the virtual grid may be parallel to the x-axis (perhaps the west direction) of the coordinate system used for the construction work area and the y-axis of the virtual grid may be parallel to the y-axis (perhaps the north direction) of the coordinate system used for the construction work area. For example, where the blocks are rectangular, the boundaries of two opposing sides of the block may be parallel to the x-axis of the coordinate system used for the construction work area (i.e., the two opposing sides of the block have a constant y-coordinate value) and the boundaries of the other two opposing sides of the block may be parallel to the y-axis of the coordinate system used for the construction work area (i.e., the other two opposing sides of the block have a constant x-coordinate value). In one option, each block of the virtual grid may have the same dimensions.

In some embodiments, the virtual grid may include a plurality of grid areas, wherein each grid area is identified by a grid area column designator and a grid area row designator, and wherein each grid area includes a subset of the blocks identified by a block designator. Without limitation, the grid area column designator may be a numerical designator in ascending order from left to right, the grid area row designator may be an alphabetic designator in ascending order from top to bottom, and the block designators may be a numerical designator in ascending order from left to right in multiple rows (i.e., 01-04 in a first row, 05-08 in a second row, 09-12 in a third row, and 13-16 in a fourth row). For such a system of designators, an individual block may be identified by a code, such as <grid area row designator><grid area column designator>-<block designator>. So, the block located in grid area row B and grid area column 3 with a block designator of 11 may be written as referred to as block B3-11. According to some embodiments, a user may request an installation work package for block B3-11 or any other block using this or other systems of designators, and the software application may use the boundaries of block B3-11 to identify construction drawings that have a location within the boundaries of that block to be included in the installation work package. Other criteria, such as a trade discipline, sequence, elevation, etc. may be used to further limit the scope of the installation work package.

Some embodiments may further comprise identifying a monument having a known physical location relative to the construction work area, wherein the origin of the virtual grid has a predetermined location relative to the known physical location of the monument. While the original of the virtual grid may coincide with the monument, this is not required. Rather, the origin may be a known distance in the x-direction from the monument and a known distance in the y-direction from the monument. Furthermore, the origin may be set at any given set of coordinates within the construction work area, such as the coordinates of a corner of the construction work area.

In some embodiments, the operation of generating a virtual grid overlaying the construction work area includes automatically generating the boundaries of each block based on a predetermined origin for the virtual grid and a predetermined block size that is repeated across the construction work area along the x-axis and the y-axis. The coordinates of the predetermined origin and/or the predetermined block size may be entered by user input to the software application. Alternatively, the predetermined origin and/or the predetermined block size may be determined by the software application to cover the entire construction work area and establish blocks having some predetermined characteristic, such as a predetermined number of man-hours of work. More specifically, the predetermined characteristic may be a predetermined number of man-hours of work for a given sequence of work within the block.

In some embodiments, each construction drawing may be a digital drawing file associated with metadata identifying the x-coordinate and y-coordinate of each of the one or more components included in the construction drawing and/or each of one or more points on the components included in the construction drawing. In the example of a section of pipe, the construction drawing may identify the location of each end of the pipe, the location of each bend in the pipe, and/or the location of each instrument, flange or other characteristic of the pipe section. Optionally, the metadata associated with each construction drawing may further identify the materials necessary to construct the one or more components included in the construction drawing. In a further option, the metadata associated with each construction drawing may further identify the equipment and/or tools necessary to construct the one or more components included in the construction drawing using the identified materials. In accordance with these options, the operations may further comprise verifying, for the one or more blocks, that the identified materials and the identified equipment and/or tools (i.e., identified in the metadata associated with the construction drawings) are available prior to generating the installation work package.

In some embodiments, the metadata associated with each construction drawing may further identify an estimated number of man-hours required to construct the one or more components included in the construction drawing. Optionally, the operations may further comprise receiving user input setting a number or range of man-hours of work to be included in the installation work package for each block and determining the size of the plurality of blocks based on the input number or range of man-hours.

In some embodiments, the metadata associated with each construction drawing may further identify, for each of a plurality of trade disciplines, an estimated number of man-hours of the trade discipline required to construct the one or more components included in the construction drawing. For example, if the one or more components in a given construction drawing require a structural steel trade discipline and a pipe fitter trade discipline, then the metadata associated with the given construction drawing may identify the estimated number of man-hours of the structural trade discipline required to construct the structural steel components of the given construction drawing and the estimated number of man-hours of the pipe fitter trade discipline required to contrast the piping components of the given construction drawing. In one option, the operation of generating an installation work package may include identifying, for each of the plurality of trade disciplines, a subset of the construction drawings of the installation work package that require the trade discipline.

In some embodiments, the metadata associated with each construction drawing may further identify a sequence code that indicates an order in which the one or more components of the construction drawing are to be constructed relative to the one or more components of other construction drawings within the same block. As a simple example, construction drawings within a given block may include some drawings with a sequence code of “01” (perhaps describing the construction of a foundation), some drawings with a sequence code of “02” (perhaps describing the construction of a structural steel framework on the foundation), some drawings with a sequence code of “03” (perhaps describing the construction of pipe supported on the structural steel framework), and some drawings with a sequence code of “04” (perhaps describing the construction and installation of electronic devices relative to the pipe). In one option, the operation of generating an installation work package may include identifying, for the one or more blocks, a subset of the construction drawings within the block that have a lowest remaining sequence code among the construction drawings within the block. The lowest remaining sequence code may, in a descending sequence code system, initially be the sequence code of “01”. However, after all the work associated with sequence codes “01” and “02” have been performed within the block, then the lowest remaining sequence code would be “03”.

In some embodiments, the meta data associated with each construction drawing may further identify an elevation of the one or more components in the construction drawing. For example, if the plan view of the construction work area describes an x-axis and a y-axis, then the elevation may be described by a z-axis. In some applications, an elevation of “100” is at grade or ground level such that elevations below grade may have a positive elevation that is less than 100 and elevations above grade may have a positive elevation that is greater than 100. In one example, a foundation that extends 10 feet below grade would begin at elevation 90 and a structure that extends 35 feet above grade would have an elevation of 135. In one option, the operation of generating an installation work package may include identifying, for the one or more blocks, a subset of the construction drawings within the block that have a lowest remaining elevation among the construction drawings within the block (i.e., the lowest elevation among components in the block that have not yet been constructed).

In some embodiments, the components having locations within more than one block may be identified and flagged or otherwise brought to a user's attention. For example, a pipe may extend between two or more adjacent blocks, such that it may be unclear whether the pipe drawing should be included in one or the other of the adjacent blocks. In one option, the operations may further include notifying the user about components that have locations within multiple blocks. The notice could be in the form of an individual notification or a list of all components having locations within multiple blocks. The user may respond to the notification or list with input indicating which of the multiple blocks should include the component(s). In another option, the operations may identify a component residing within (i.e., having one or more location within) multiple blocks and apply one or more predetermined criteria to automatically identify a particular block to which the drawing of the component should be included. The predetermined criteria may, for example, include assigning the component or drawing to: (1) the block where the majority of the component is located, (2) the block having fewer man-hours of work to be performed, (3) the block to which other supporting structure is assigned (i.e., a foundation), and/or (4) the block that is otherwise expected to already have the necessary trade disciplines available. Optionally, the drawing of a component residing in multiple blocks may be automatically assigned using these or other criteria, or these or other criteria may be used to generate a notification suggesting assignment of the component drawing to a particular block subject to user input indicating whether the suggestion should be accepted or rejected. Furthermore, the notification may include a ranked list of blocks to which the drawing may be assigned, such that the user input may select the top ranked block or any other lower ranked block based on their own knowledge of the situation.

Some embodiments may be directed to a method of performing the operations described herein and any aspect of the operations described herein. Furthermore, some embodiments may be directed to a system for performing the operations described herein.

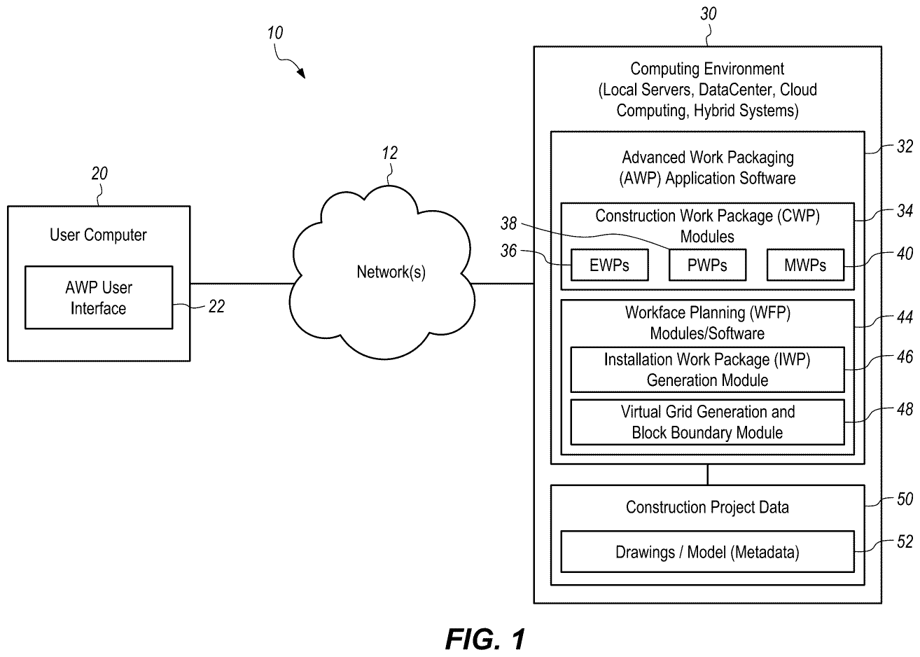

FIG. 1 is a diagram of a system 10 in which a user computer 20 can access and utilize an advanced work packaging (AWP) software application 32 according to some embodiments. The user computer 20 may run an AWP user interface application 22 that enables access to the AWP software application 32 over one or more networks 12.

The AWP software application 32 is performed in a computing environment 30, such as one or more local servers, a datacenter, a cloud computing environment, or a hybrid computing system. The AWP software application 32 includes construction work package (CWP) modules and workface planning (WFP) modules or software. The construction work package (CWP) modules 34 may, without limitation, include one or more engineering work package (EWP) modules 36, one or more procurement work package (PWP) modules 38, and one or more module work package (MWP) modules 40. The workface planning (WFP) modules of the AWP software application or standalone WFP software 44 includes an installation work package (IWP) generation module 46 and a virtual grid generation and block boundary module 48.

In addition to the AWP software application 32, the computing environment 30 stores construction project data 50, such as drawings and/or model data and associated metadata 52. Accordingly, the AWP software application 32 may load the construction project data 50, such as engineering, procurement and module data, to form a construction work package (CWP). Furthermore, the workface planning (WFP) modules or standalone software application 44 may generate a virtual grid defining individual block boundaries using the virtual grid generation and block boundary module 48 and generate an installation work package (IWP) using the installation work package (IWP) generation module 46. Furthermore, the system 10 may be used to perform any of the operations described herein and any aspect thereof.

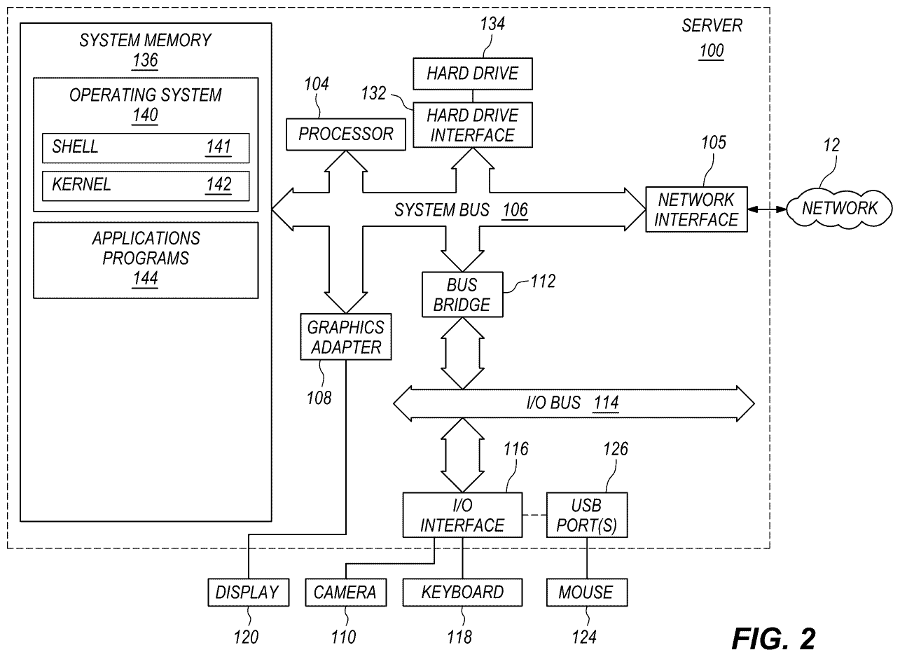

FIG. 2 is a diagram of a server 100 according to some embodiments. The server 100 may be representative of a server in the computing environment 30 that runs the AWP application software 32 and/or representative of the user computer 20 that accesses the AWP application software 32 using the AWP user interface 22 as shown in FIG. 1. In one option, the AWP user interface 22 may be a browser application.

The server 100 includes a processor unit 104 that is coupled to a system bus 106. The processor unit 104 may utilize one or more processors, each of which has one or more processor cores. An optional graphics adapter 108, which may or may not drive/support an optional display 120, is also coupled to the system bus 106. The graphics adapter 108 may, for example, include a graphics processing unit (GPU). The system bus 106 may be coupled via a bus bridge 112 to an input/output (I/O) bus 114. An I/O interface 116 is coupled to the I/O bus 114, where the I/O interface 116 affords a connection with various optional I/O devices, such as a camera 110, a keyboard 118 (such as a touch screen virtual keyboard), and a USB mouse 124 via USB port(s) 126 (or other type of pointing device, such as a trackpad). As depicted, the computer 100 is able to communicate with other network devices over a network 12, such as the wide area network, using a network adapter or network interface controller 105.

A hard drive interface 132 is also coupled to the system bus 106. The hard drive interface 132 interfaces with a hard drive 134. In a preferred embodiment, the hard drive 134 may communicate with system memory 136, which is also coupled to the system bus 106. The system memory may be volatile or non-volatile and may include additional higher levels of volatile memory (not shown), including, but not limited to, cache memory, registers and buffers. Data that populates the system memory 136 may include the operating system (OS) 140 and application programs 144. The hardware elements depicted in the server 100 are not intended to be exhaustive, but rather are representative.

The operating system 114 includes a shell 141 for providing transparent user access to resources such as application programs 144. Generally, the shell 141 is a program that provides an interpreter and an interface between the user and the operating system. More specifically, the shell 141 may execute commands that are entered into a command line user interface or from a file. Thus, the shell 141, also called a command processor, is generally the highest level of the operating system software hierarchy and serves as a command interpreter. The shell may provide a system prompt, interpret commands entered by keyboard, mouse, or other user input media, and send the interpreted command(s) to the appropriate lower levels of the operating system (e.g., a kernel 142) for processing. Note that while the shell 141 may be a text-based, line-oriented user interface, the present invention may support other user interface modes, such as graphical, voice, gestural, etc.

As depicted, the operating system 140 also includes the kernel 142, which includes lower levels of functionality for the operating system 140, including providing essential services required by other parts of the operating system 140 and application programs 144. Such essential services may include memory management, process and task management, disk management, and mouse and keyboard management. In addition, the computer server 100 may include application programs 144 stored in the system memory 136. Where the server 100 represents a server in the computing environment 30 of FIG. 1, the application programs 144 may include the AWP application software 32 and the hard drive 134 may store the construction project data 50. Where the server 100 represents a user computer 20 of FIG. 1, the application programs 144 may include the AWP user interface 22.

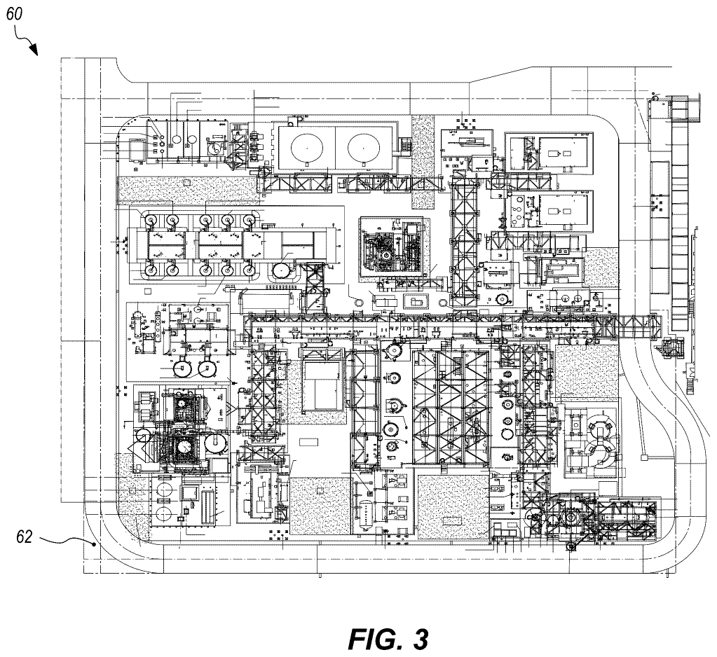

FIG. 3 is a diagram of a plot plan illustrating the construction work area 60 for a construction project for which a construction work package (CWP) has been prepared using the advanced work packaging (AWP) software application. The construction work package describes the construction of a chemical processing plant, including foundations, steel support structures, vessels, tanks, pipe and other equipment. For the purpose of this illustration, it is not important to see the exact detail of the plot plan, but rather to recognize that there are particular components to be constructed at particular locations across the construction work area 60. The location of each component and/or various points on a component are defined within the construction work package. For example, each component in the construction work area 60 may be described and/or illustrated in a construction drawing that is associated with metadata describing various aspects of the component and its location within the construction work area.

The location of each component may be correlated with a monument 62, which is shown as Monument 13 (“Mon13”) having a location at West 146437.807, North 90484.757, and Elevation 30650.688. All of these measurements are in millimeters.

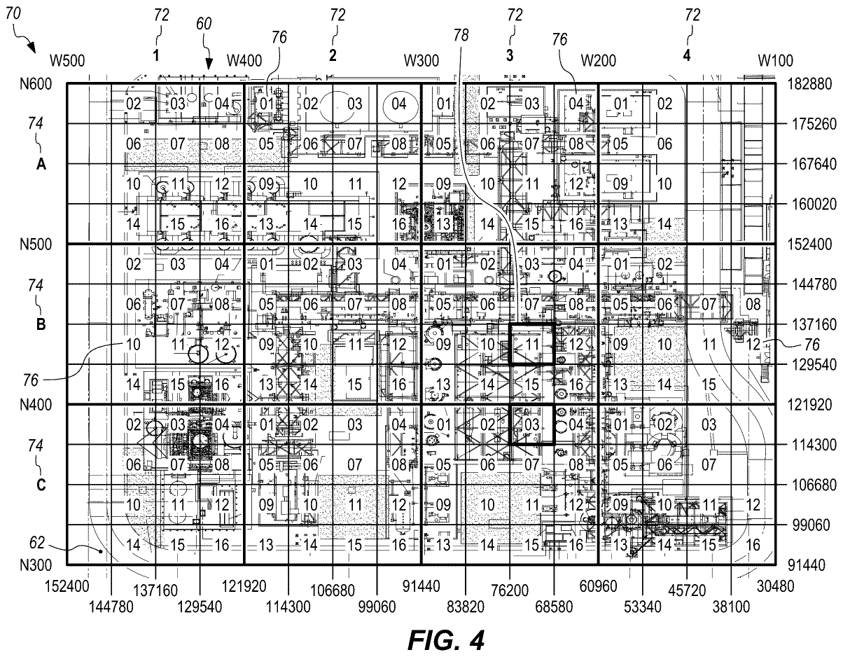

FIG. 4 is a diagram of a virtual grid 70 overlaying the construction work area 60 of the construction project. The virtual grid 70 includes a plurality of grid areas, wherein each grid area is identified by a grid area column designator (1-4 from left to right) 72, a grid area row designator (A-C from top to bottom) 74, and a block designator 76 within each grid area (01-16 from left to right in each of four rows; namely 01-04 in a first row, 05-08 in a second row, 09-12 in a third row, and 13-16 in a fourth row). For example, using this system of designators, the individual block 78 may be identified by a block code of B3-11. According to some embodiments, a user may request an installation work package for block B3-11, and the software application may use the boundaries of block B3-11 to identify construction drawings that have a location within the boundaries of that block to be included in the installation work package. Other criteria, such as a trade discipline, sequence, elevation, etc. may be used to further limit the scope of the installation work package.

In reference to FIG. 4, the virtual grid has established each of the blocks with the same size (area) and dimensions. Given that there are 3 row designators (A-C) and 4 column designators, there are 12 grid areas. Since each grid area include 16 blocks, there is a total of 192 blocks shown in FIG. 4. However, the block designator is not shown on 25 of the blocks since there are no components to be constructed within the area of these blocks.

The x-axis (horizontal axis in FIG. 4) is also labeled across the top with a West distance (i.e., W100, W200, W300, W400 and W500 from right to left) and the y-axis (vertical axis in FIG. 4) is labeled across the left side with a North distance (i.e., N300, N400, N500 and N600 from bottom to top). Still further, the x-axis is labeled across the bottom with distance measurements stated in units of millimeters. Accordingly, it is shown that the x-dimension of each block is 7620 millimeters (7.62 meters) and the y-dimension of each block is also 7620 millimeters (7.62 meters).

In the non-limiting illustration of FIG. 4, the grid lines, grid areas and blocks overlay the entire construction work area 60 but none of the grid lines or block boundaries necessarily intersect the monument location 62. Rather, the virtual grid 70 must cover an area extend across the entire construction work area 60, including the furthest North component location (such as in block A1-02), the least North component location (such as in block C1-16), the furthest West component location (such as in block B1-06), and the least West component location (such as in block B4-12). The virtual grid 70 may then sub-divide the area into blocks having a particular size or content according to any of the embodiments. For example, user input could establish the dimensions that are to be used to calculate the boundaries for each block of the virtual grid. Alternatively, the size of the blocks could be determined so that the number of man-hours of work required within a given block is less than a maximum number of man-hours or within a range of man-hours. Other criteria for establishing the size of a block may also be used.

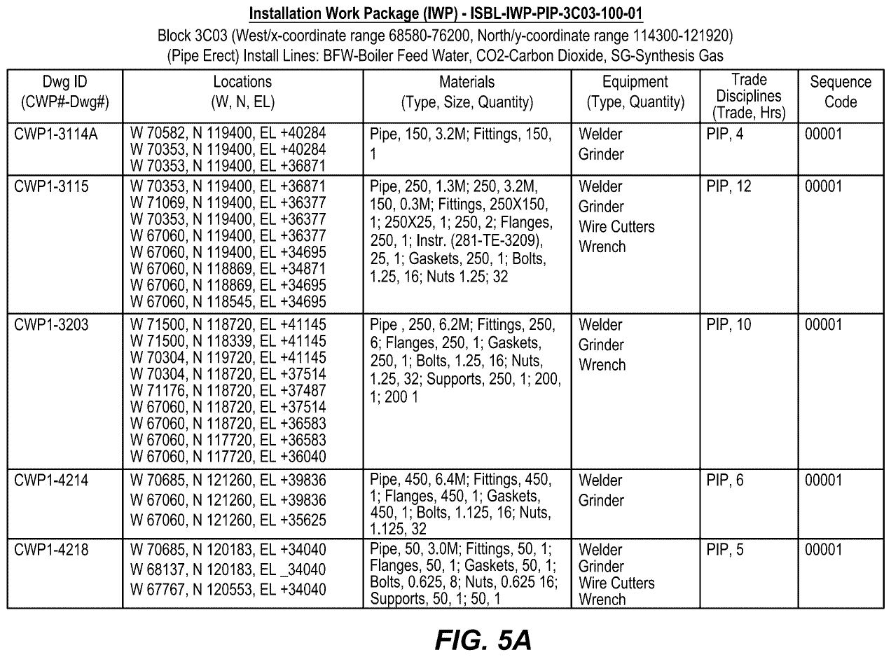

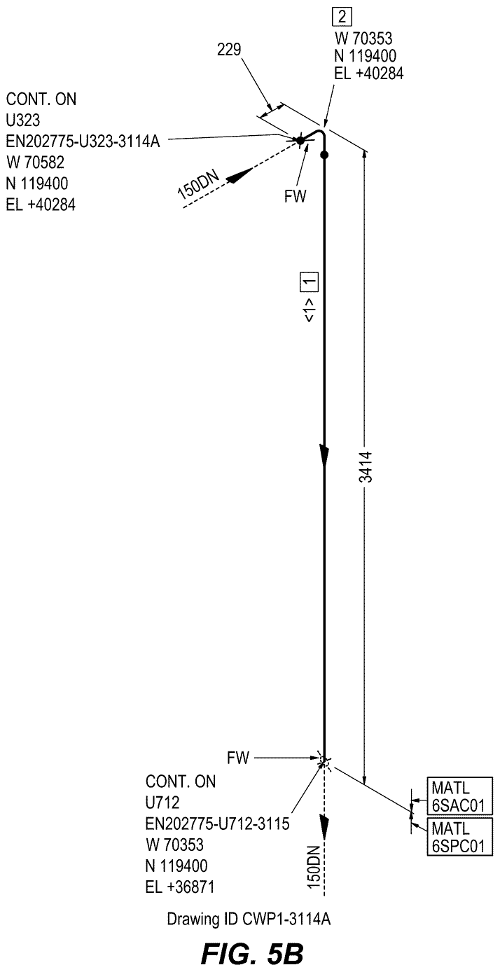

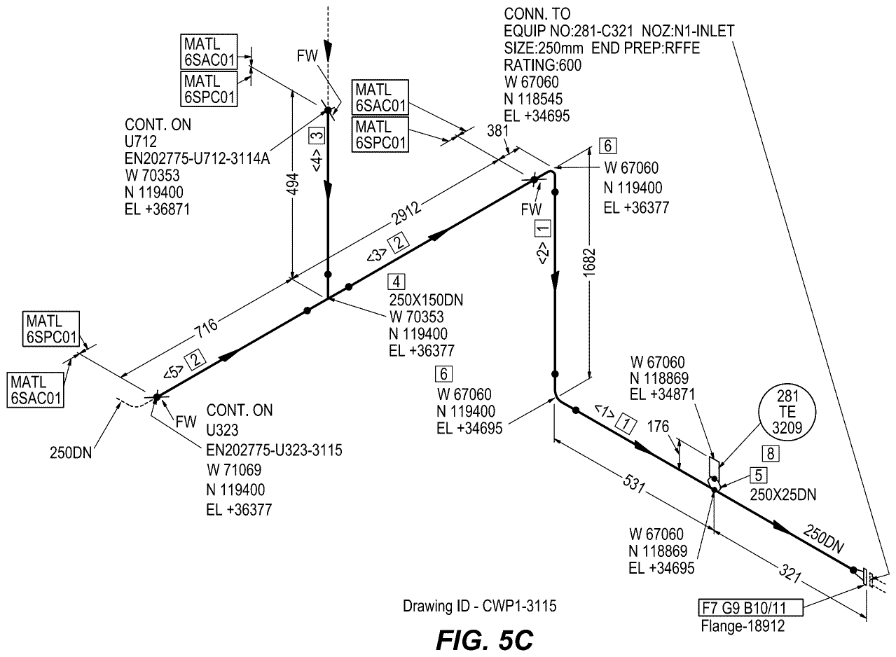

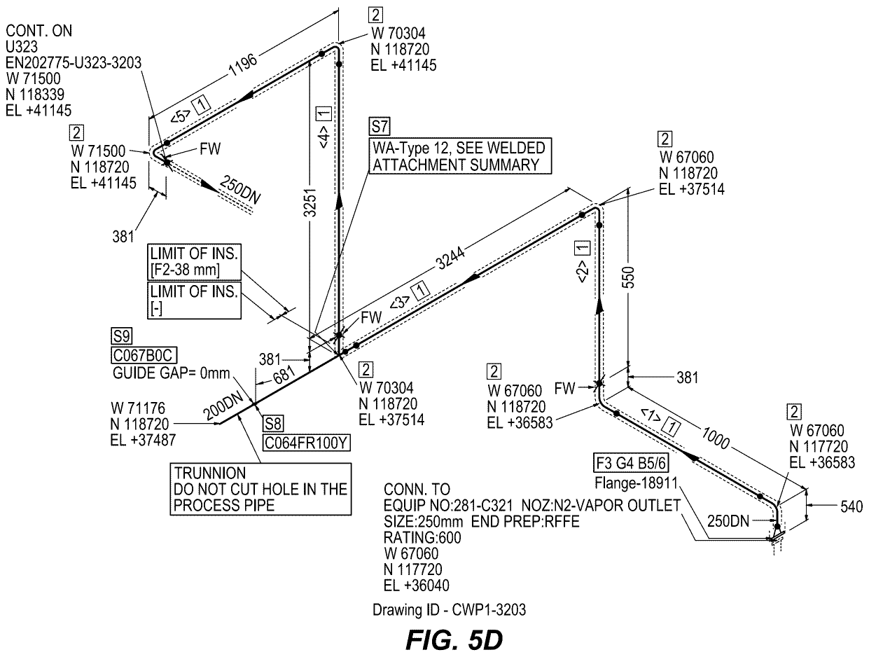

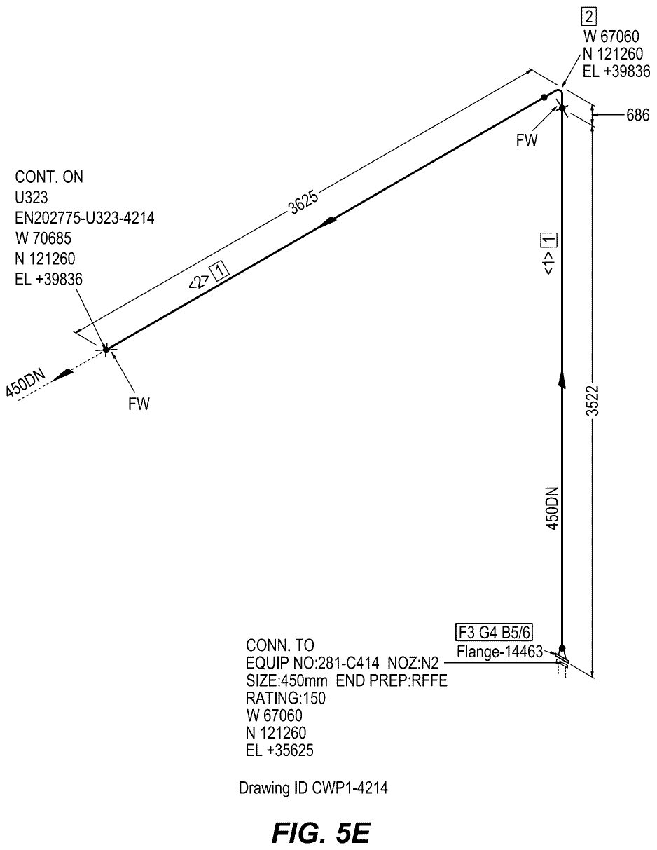

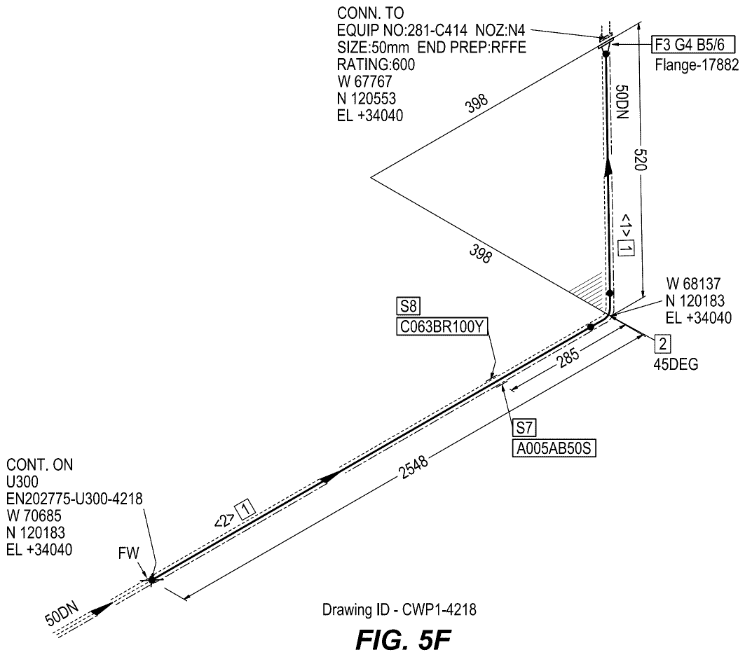

In the example of the highlighted individual block 78 identified as block B3-11, the block has boundaries defined by have both the x-axis range from 68580 to 76200 and the y-axis range from 129540 to 137160 and encompasses that portion of the construction work area 60 within those block boundaries. An installation work package for block 3C-03 (or simply “3C03”) is discussed in reference to FIGS. 5A-F.

FIG. 5A is a table representing the content of an installation work package (IWP) covering that portion of the construction work area located with block 3C03 of the virtual grid shown in FIG. 4. The IWP is identified by a reference number ISBL-IWP-PIP-3C03-100-01 which follows the format: <ISBL>_<Type of Package>-<trade discipline>-<grid code>-<elevation>-<sequence code>. ISBL stands for “Inside Battery Limits” which refers to the area inside boundary that separates the construction work area from the surrounding area. The “Type of Package” is an installation work package (IWP). The “trade discipline” is a pipe fitter (PIP), meaning that the IWP is specific to work to be done by a pipe fitter. The “grid code” (or block identifier) is 3C03, which is block 03 within the grid area 3C (see FIG. 4). The “elevation” is 100, which indicates that the work is done at grade (ground level). The “sequence code” is 01, which indicates that the work may be performed without any prior work done in the block.

As noted in the header of the table, block 3C03 has boundaries defined by the West/x-coordinate range 68580-76200 and North/y-coordinate range 114300-121920. The IWP for block 3C03 will include construction drawings having locations that fall within both of these ranges. Specifically, a construction drawing that is part of the construction work package is included in the IWP if the drawing has one or more components with a West (x-coordinate) within the x-coordinate range 68580-76200 and a North (y-coordinate) within the y-coordinate range 114300-121920. Using these coordinate ranges, the workface planning software may search all of the construction drawings in the construction work package to identify those constructions drawings having one or more component location that is within the ranges of the selected block 3C03. It should be kept in mind that the construction work package includes a large number of drawings for components throughout the construction work area and that an IWP like that of FIGS. 5A-F may be generated for any one or more of the blocks established by the virtual grid. In fact, multiple IWPs may, over the duration of the construction project, be generated at different times. For example, a sequence of IWPs may be generated for a selected block, such as one IWP per week, to construct different components.

The first column of FIG. 5A shows that five construction drawings have been identified as having component locations within the x and y coordinate ranges of block 3C03. For example, construction drawing CWP1-3114A has metadata indicating that one of the components or one point on a component of the drawing is at W 70582, N 119400. W 70582 falls within the West/x-coordinate range 68580-76200 and N 119400 falls within the North/y-coordinate range 114300-121920. Furthermore, the drawing CWP1-3114A has metadata indicating that a pipe fitter (PIP) is required for construction of the components in the drawing. Accordingly, drawing CWP1-3114A is included in the installation work package (ISBL-IWP-PIP-3C03-100-01).

More generally, FIG. 5A represents all of the drawings (column 1) included in the IWP and the metadata (columns 2-6) associated with each of the drawings. In some embodiments, the workface planning software will use the metadata to determine whether a drawing has a location within the selected block and whether the IWP is ready to be performed. For example, an IWP may be ready to be perform if the necessary materials (column 3) are available on site, the necessary equipment (column 4) is available on site, the trade discipline(s) (column 5) are available for the required number of hours, and the sequence code is the lowest remaining sequence code for all of the drawings associated with the selected block. In other words, a construction drawing with a sequence code of “00003” should not be performed until all of the construction work associated with construction drawings having a sequence code of “00001” and “00002” have been completed. Note that this IWP includes 5 construction drawings that each have a sequence code of “00001”. There may be subsequent IWPs having other sequence codes for the selected block involving different materials, equipment, and/or trade disciplines. For the present example elevation has been ignored, but elevation could be used by the workface planning software to further limit the scope of an IWP.

FIG. 5B is a construction drawing (Drawing ID—CWP1-3114A) for a first pipe located within the block 3C03. The construction drawing identifies the location for each end and each bend in the pipe using West, North and Elevation measurements. These same locations were noted in the IWP table of FIG. 5A and were used by the workface planning software to determine that the construction drawing should be included in the IWP. The data from the construction drawing may be available in a computer readable format as metadata about the components to be constructed according to the drawing. For example, the CWP1-3114A drawings may be associated with metadata identifying, without limitation, the following materials:

### Fabrication Materials

### Pipe:

Pipe, ASME B36.19, Beveled End, ASTM A312 Grade TP304/TP304L, Seamless, SCH/THK S- 40S; Size: 150; Item Code: I1995318; Quantity 3.2 M

### Fittings:

90 Degree Long Radius Elbow, ASME B16.9, Beveled End, ASTM A403 Grade WP304/WP304L, Type S, SCH/THK S-40S; Size: 150; Item Code I1363843; Quantity: 1

FIG. 5C is a construction drawing (Drawing ID—CWP1-3115) for a second pipe located within the block 3C03 and 3C04. The construction drawing identifies the location for each end and each bend in the pipe using West, North and Elevation measurements. Notice that three points on the pipe (i.e., the three points on the left-hand side of the drawing) have West measurements that place them in block 3C03, whereas four points on the pipe (i.e., the four points on the right-hand side of the drawing) have a West measurement of 67060, which means that these points reside in block 3C04. While the construction drawing (Drawing ID - CWP1-3115) could be included in the IWP for either block 3C03 or 3C04, this drawing has been included in ISBL-IWP-PIP-3C03-100-01 either due to a user decision and input or as a result of an operation that applies predetermined criteria to make an automated decision or suggestion. These same locations were noted in the IWP table of FIG. 5A and were used by the workface planning software to determine that the construction drawing should be included in the IWP for block 3C03. The data from the construction drawing may be available in a computer readable format as metadata about the components to be constructed according to the drawing. For example, the CWP1-3115 drawing may be associated with metadata identifying, without limitation, the following materials:

### Fabrication Materials

### Pipe:

Pipe, ASME B36.19, Beveled End, ASTM A312 Grade TP 304/TP304L, 100% Radiography, Electric Fusion Welded (Ej=1.00), SCH/THK S-80S; Size: 250; Item Code: I1995385; Quantity: 1.3 M
Pipe, ASME B36.19, Beveled End, ASTM A790 (UNS S31803), 100% Radiography, Electric Fusion Welded (Ej=1.00), SCH/THK S-80S; Size: 250; Item Code: I2WXKZ9; Quantity: 3.2 M
Pipe, ASME B36.19, Beveled End, ASTM A790 (UNS S31803), 100% Radiography, Electric Fusion Welded (Ej=1.00), SCH/THK S-40S; Size: 150; Item Code: I2WXKY1; Quantity: 0.3 M

### Fittings:

Reducing Tee, ASME B16.9, Beveled End, ASTM A815 Grade WPS31803 (UNS S31803), Type S, SCH/THK S-80S, SCH/THK S-40S; Size: 250×150; Item Code: I2VYT66; Quantity: 1
Sockolet®, Reducing, MSS SP-97, Class 3000, Socket Welded End, ASTM A182 Grade F 304/F 304L; Size: 250×25; Item Code: I1968420; Quantity: 1
90 Degree Long Radius Elbow, ASME B16.9, Beveled End, ASTM A403 Grade WP304/WP304L, Type WX, SCH/THK S-80S; Size: 250; Item Code: I1363973; Quantity: 2

### Flanges:

Weld Neck Flange, ASME B16.5, Class 600, Raised-face flanged end, ASTM A182 Grade F 304/F 304L, SCH/THK S- 80S; Size: 250; Item Code: I1698210; Quantity: 1

### Instruments

SEE INSTRUMENT SUMMARY; Size: 25; Item Code: 281-TE-3209; Quantity: 1

### Erection Materials

### Gaskets:

Spiral Wound Gasket, ASME B16.20, for ASME B16.5 Flanges, Class 600, 304 stainless steel (18 Cr-8 Ni), w/flexible graphite filler, w/304 SS inner ring and CS outer ring; Size: 250; Item Code: GSWAB9LAZHBACZ; Quantity: 1

### Bolts:

Stud Bolt (IN-MM)—, ASTM A193 Grade B7, Studs—230 mm Length; Size: 1¼; Item Code: LSBAZZAX5AAHZ; Quantity: 16
Hexagonal Head Nut, ASME B18.2.2 Heavy Hex, ASTM A194 Grade 2H; Size: 1¼; Item Code: LNAAHHAX3ZZZZ_1.25_1.251; Quantity: 32
FIG. 5D is a construction drawing (Drawing ID—CWP1-3203) for a third pipe located within the block 3C03. The construction drawing identifies the location for each end and each bend in the pipe using West, North and Elevation measurements. These same locations were noted in the IWP table of FIG. 5A and were used by the workface planning software to determine that the construction drawing should be included in the IWP. The data from the construction drawing may be available in a computer readable format as metadata about the components to be constructed according to the drawing. For example, the CWP1-3203 drawing may be associated with metadata identifying, without limitation, the following materials:

### Fabrication Materials

### Pipe:

Pipe, ASME B36.19, Beveled End, ASTM A312 Grade TP304/TP304L, Electric Fusion Welded, (Ej=0.80), SCH/THK S- 40S; Size: 250; Item Code: I1995355; Quantity: 6.2 M

### Fittings:

90 Degree Long Radius Elbow, ASME B16.9, Beveled End, ASTM A403 Grade WP304/WP304L, Type W, SCH/THK S-40S; Size: 250; Item Code: I1363850; Quantity: 6

### Flanges:

Weld Neck Flange, ASME B16.5, Class 600, Raised-face flanged end, ASTM A182 Grade F 304/F 304L, SCH/THK S- 40S; Size: 250; Item Code: I1698208; Quantity: 1

### Erection Materials

### Gaskets:

Spiral Wound Gasket, ASME B16.20, for ASME B16.5 Flanges, Class 600, 304 stainless steel (18 Cr-8 Ni), w/flexible graphite filler, w/304 SS inner ring and CS outer ring; Size: 250; Item Code: GSWAB9LAZHBACZ; Quantity: 1

### Bolts:

Stud Bolt (IN-MM)—, ASTM A193 Grade B7, Studs-230 mm Length; Size: 1¼; Item Code: LSBAZZAX5AAHZ; Quantity: 16
Hexagonal Head Nut, ASME B18.2.2 Heavy Hex, ASTM A194 Grade 2H; Size: 1¼; Item Code: LNAAHHAX3ZZZZ_1.25_1.251; Quantity: 32

### Supports:

WA-Type 12, SEE WELDED ATTACHMENT SUMMARY, Rev. ; Size; 250; Item Code: WA-U712-042; Quantity: 1
C064FR100Y, Rev. 0, Pipe Shoe; Size: 200; Item Code: PS-U712-042; Quantity: 1
C067B0C, Rev. 0, Shoe Guide; Size: 200; Item Code: PS-U712-042; Quantity: 1
FIG. 5E is a construction drawing (Drawing ID—CWP1-4214) for a fourth pipe located within the block 3C03. The construction drawing identifies the location for each end and each bend in the pipe using West, North and Elevation measurements. These same locations were noted in the IWP table of FIG. 5A and were used by the workface planning software to determine that the construction drawing should be included in the IWP. The data from the construction drawing may be available in a computer readable format as metadata about the components to be constructed according to the drawing. For example, the CWP1-4214 drawing may be associated with metadata identifying, without limitation, the following materials:

### Fabrication Materials

### Pipe:

Pipe, ASME B36.19, Beveled End, ASTM A312 Grade TP304/TP304L, Electric Fusion Welded, (Ej=0.80), SCH/THK S- 10S; Size: 450; Item Code: I1995358; Quantity: 6.4 M

### Fittings:

90 Degree Long Radius Elbow, ASME B16.9, Beveled End, ASTM A403 Grade WP304/WP304L, Type W, SCH/THK S-10S; Size: 450; Item Code: I1363897; Quantity: 1

### Flanges:

Weld Neck Flange, ASME B16.5, Class 150, Raised-face flanged end, ASTM A182 Grade F 304/F 304L,-, SCH/THK S- 10S; Size: 450; Item Code: I1686198; Quantity: 1

### Erection Materials

### Gaskets:

Spiral Wound Gasket, ASME B16.20, for ASME B16.5 Flanges, Class 150, 304 stainless steel (18 Cr-8 Ni), w/flexible graphite filler, w/304 SS inner ring and CS outer ring, Low stress; Size: 450; Item Code: GSWAB9DAZHBABZ; Quantity: 1

### Bolts:

Stud Bolt (IN-MM)—, ASTM A193 Grade B7, Studs- 165 mm Length; Size: 1⅛; Item Code: LSBAZZAX5AAHZ; Quantity: 16
Hexagonal Head Nut, ASME B 18.2.2 Heavy Hex, ASTM A194 Grade 2H; Size: 1⅛; Item Code: LNAAHHAX3ZZZZ_1.125_1.139; Quantity: 32

FIG. 5F is a construction drawing (Drawing ID—CWP1-4218) for a fifth pipe located within the block 3C03. The construction drawing identifies the location for each end and each bend in the pipe using West, North and Elevation measurements. These same locations were noted in the IWP table of FIG. 5A and were used by the workface planning software to determine that the construction drawing should be included in the IWP. The data from the construction drawing may be available in a computer readable format as metadata about the components to be constructed according to the drawing. For example, the CWP1-4218 drawing may be associated with metadata identifying, without limitation, the following materials:

### Fabrication Materials

### Pipe:

Pipe, ASME B36.19, Beveled End, ASTM A312 Grade TP304/TP304L, Seamless, SCH/THK S- 10S; Size: 50; Item Code: I1995324; Quantity: 3.0 M

### Fittings:

45 Degree Long Radius Elbow, ASME B16.9, Beveled End, ASTM A403 Grade WP304/WP304L, Type S, SCH/THK S-10S; Size: 50; Item Code: I1358697; Quantity: 1

### Flanges:

Weld Neck Flange, ASME B16.5, Class 600, Raised-face flanged end, ASTM A182 Grade F 304/F 304L, SCH/THK S- 10S; Size: 50: Item Code: I1698120; Quantity: 1

### Erection Materials

### Gaskets:

Spiral Wound Gasket, ASME B16.20, for ASME B16.5 Flanges, Class 600, 304 stainless steel (18 Cr-8 Ni), w/flexible graphite filler, w/304 SS inner ring and CS outer ring; Size: 50; Item Code: GSWAB9LAZHBACZ; Quantity: 1

### Bolts:

Stud Bolt (IN-MM)-, ASTM A193 Grade B7, Studs—120 mm Length; Size: ⅝; Item Code: LSBAZZAX5AAHZ; Quantity: 8
Hexagonal Head Nut, ASME B 18.2.2 Heavy Hex, ASTM A194 Grade 2H; Size: ⅝; Item Code: LNAAHHAX3ZZZZ_.625_.631; Quantity: 16

### Supports:

A005AB50S, Rev. 0; Size: 50; Item Code: PS-U712-1701; Quantity: 1
C063BR100Y, Rev. 0, Pipe Shoe; Size: 50; Item Code: PS-U712-1701; Quantity: 1

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising a non-transitory computer readable medium and program instructions embodied therein, the program instructions being configured to be executable by a processor to cause the processor to perform operations comprising:
accessing a construction work package that identifies a plurality of construction drawings that are collectively necessary for physical execution of a construction project covering a construction work area, wherein each construction drawing includes the design of one or more components and a location within the construction work area for each of the components;
generating a virtual grid overlaying the construction work area, wherein the virtual grid divides the construction work area into a plurality of blocks having boundaries; and
generating, for one or more blocks, an installation work package that includes the construction drawings from the construction work package that are necessary for physical execution of that portion of the construction project within the construction work area that is within the boundaries of the block.

2. The computer program product of claim 1, wherein the virtual grid establishes an x-axis and a y-axis, wherein the boundaries of each block are established by a range of x-coordinates and a range of y-coordinates, and wherein the installation work package includes some or all of the construction drawings that have a location with an x-coordinate within the range of x-coordinates for the block and a y-coordinate within the range of y-coordinates for the block.

3. The computer program product of claim 2, wherein each block has the same dimensions along the x-axis and the same dimensions along the y-axis.

4. The computer program product of claim 2, wherein generating a virtual grid overlaying the construction work area includes automatically generating the boundaries of each block based on a predetermined origin for the virtual grid and a predetermined block size that is repeated across the construction work area along the x-axis and the y-axis.

5. The computer program product of claim 1, further comprising:
identifying a monument having a known physical location relative to the construction work area, wherein the origin of the virtual grid has a predetermined location relative to the known physical location of the monument.

6. The computer program product of claim 1, wherein each construction drawing is a digital drawing file associated with metadata identifying the x-coordinate and y-coordinate of each of the one or more components included in the drawing.

7. The computer program product of claim 6, wherein the metadata associated with each construction drawing further identifies the materials necessary to construct the one or more components included in the construction drawing.

8. The computer program product of claim 7, wherein the metadata associated with each construction drawing further identifies the equipment and/or tools necessary to construct the one or more components included in the construction drawing using the identified materials.

9. The computer program product of claim 8, further comprising:
verifying, for the one or more blocks, that the identified materials and the identified equipment and/or tools are available prior to generating the installation work package.

10. The computer program product of claim 6, wherein the metadata associated with each construction drawing further identifies an estimated number of man-hours required to construct the one or more components included in the construction drawing.

11. The computer program product of claim 10, further comprising:
receiving user input setting a number of man-hours of work to be included in the installation work package for each block; and
determining the size of the plurality of blocks based on the input number of man-hours.

12. The computer program product of claim 6, wherein, for each of a plurality of trade disciplines, the metadata associated with each construction drawing further identifies an estimated number of man-hours of the trade discipline required to construct the one or more components included in the construction drawing.

13. The computer program product of claim 12, wherein the operation of generating an installation work package includes identifying, for each of the plurality of trade disciplines, a subset of the construction drawings of the installation work package that require the trade discipline.

14. The computer program product of claim 6, wherein the metadata associated with each construction drawing further identifies a sequence code that indicates an order in which the one or more components of the construction drawing are to be constructed relative to the one or more components of other construction drawings within the same block.

15. The computer program product of claim 14, wherein the operation of generating an installation work package includes identifying, for the one or more blocks, a subset of the construction drawings within the block that have a lowest remaining sequence code among the construction drawings within the block.

16. The computer program product of claim 6, wherein the meta data associated with each construction drawing further identifies an elevation of the one or more components in the construction drawing.

17. The computer program product of claim 16, wherein the operation of generating an installation work package includes identifying, for the one or more blocks, a subset of the construction drawings within the block that have a lowest remaining elevation among the construction drawings within the block.

18. The computer program product of claim 1, wherein the virtual grid is formed by a two-dimensional cartesian coordinate system.

19. The computer program product of claim 1, wherein the virtual grid includes a plurality of grid areas, wherein each grid area is identified by a grid area column designator and a grid area row designator, and wherein each grid area includes a subset of the blocks identified by a block designator.

20. The computer program product of claim 1, wherein the installation work package for one or more blocks is generated in response to user input identifying the one or more blocks for which the installation work package is requested.
